(19) United States
(12) Patent Application Publication
(10) Pub. No.: US 2017/0267288 A1
(43) Pub. Date: Sep. 21, 2017

(54) AUTOMATIC PARALLEL PARKING OF VEHICLE EQUIPPED WITH MANUAL TRANSMISSION

(71) Applicant: BorgWarner Inc., Auburn Hills, MI (US)

(72) Inventors: Joel MAGUIRE, Hartland, MI (US); Mark Ray BUCHANAN, Rochester Hills, MI (US)

(21) Appl. No.: 15/531,878

(22) PCT Filed: Nov. 23, 2015
(86) PCT No.: PCT/US2015/062054

§ 371 Date: May 31, 2017

Related U.S. Application Data
(60) Provisional application No. 62/085,787, filed on Dec. 1, 2014.

(51) Int. Cl. B62D 15/02

(52) U.S. Cl. CPC B62D 15/0285; B62D 15/026; B62D 15/0265; B62D 9/00

(57) ABSTRACT

A system and method of parking a vehicle is disclosed. A vehicle may be provided with a manual transmission. The vehicle may be equipped with an automatically modulated clutch. A target parking space may be identified. The clutch may be modulated automatically through a controller to move the vehicle while scanning the target parking space. The vehicle may be automatically steered through the controller while simultaneously modulating the clutch automatically through the controller to move the vehicle into the target parking space.

### CROSS-REFERENCE TO RELATED APPLICATIONS

This application claims the benefit of U.S. Provisional Application No. 62/085,787 filed Dec. 1, 2014.

### TECHNICAL FIELD

The field to which the disclosure generally relates includes methods of parking a vehicle.

### BACKGROUND

Parking a vehicle may present a number of challenges to drivers. Parallel parking in particular, may require a number of decisions and actions to effectively reposition the vehicle from a traffic lane into a limited space that may be adjacent to a curb. A typical automobile may be equipped with a number of sensors and actuators for various purposes. Some parking systems may use these sensors and actuators to scan the surroundings and assist a driver in parking a vehicle by prompting the vehicle's driver to provide accurate steering inputs suitable for maneuvering the vehicle into the selected parking space. Other parking systems may control steering inputs, while relying on the driver to operate the accelerator and brake pedals. Such systems may be referred to as semi-autonomous, in that they rely on the driver to ultimately control inputs needed to move the vehicle completely into a selected parking space.

Other described vehicle parking systems may be intended to control steering, engine, and automatic transmission operation to maneuver the vehicle into a selected parking space. These systems may be referred to as autonomous, in that the driver may initiate operation of the parking activity, but then electronic controllers may use various sensed inputs to process data and control the vehicle systems needed to completely park the vehicle.

Equipping a vehicle with a manual transmission may compound the challenges associated with parking a vehicle. In addition to steering the vehicle and operating the accelerator and brakes, a clutch must be actuated to engage the drivetrain to move the vehicle, and to disengage the drivetrain to stop the vehicle.

### SUMMARY OF ILLUSTRATIVE VARIATIONS

A number of illustrative variations may include methods of parking a vehicle. In these methods, a vehicle may be provided with a manual transmission. The vehicle may be equipped with an automatically modulated clutch. A target parking space may be identified, and the clutch may be modulated automatically through a controller to move the vehicle while scanning the target parking space. The vehicle may then be automatically steered through a controller while simultaneously modulating the clutch automatically through a controller to move the vehicle into the target parking space.

A number of other illustrative variations may include methods of parking a vehicle that is equipped with a manually actuated transmission. In these methods the vehicle may be equipped with an automatically modulated clutch. A target parking space may be identified, and the vehicle may be stopped at a first location that is rearward and to a side of the target parking space. The clutch may be modulated automatically through a controller to autonomously move the vehicle in a forward direction while scanning the target parking space. The vehicle may be stopped at second location that is forward and to the side of the target parking space. The transmission may be manually shifted into reverse. The vehicle may then be steered automatically while the controller simultaneously modulates the clutch automatically to move the vehicle into the target parking space.

Other illustrative variations may include a system for automatically parking a vehicle that has an engine and a manually operated transmission. The system may include a sensor configured to detect objects proximate to the vehicle, and a steering system for steering the vehicle. A clutch may be configured to engage and disengage the engine and the manual operated transmission. Controllers may autonomously control the steering and may autonomously actuate the vehicle's clutch. The controllers may determine a boundary of a target parking space based on location of the objects detected by the sensor, and may autonomously control the steering and actuate the clutch to effect movement of the vehicle into the target parking space.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a block schematic diagram of an automatic parking system according to a number of variations.

FIG. 2 is a geometric schematic diagram of the identification of a target parking space for an automatic parking system according to a number of variations.

FIG. 3 is a geometric schematic diagram of scanning of a target parking space for an automatic parking system according to a number of variations.

FIG. 4 is a geometric schematic diagram of completion of the scanning of a target parking space for an automatic parking system according to a number of variations.

FIG. 5 is a geometric schematic diagram of parking maneuver by an automatic parking system according to a number of variations.

### DETAILED DESCRIPTION OF ILLUSTRATIVE VARIATIONS

The following description of the variations is merely illustrative in nature and is in no way intended to limit the scope of the invention, its application, or uses.

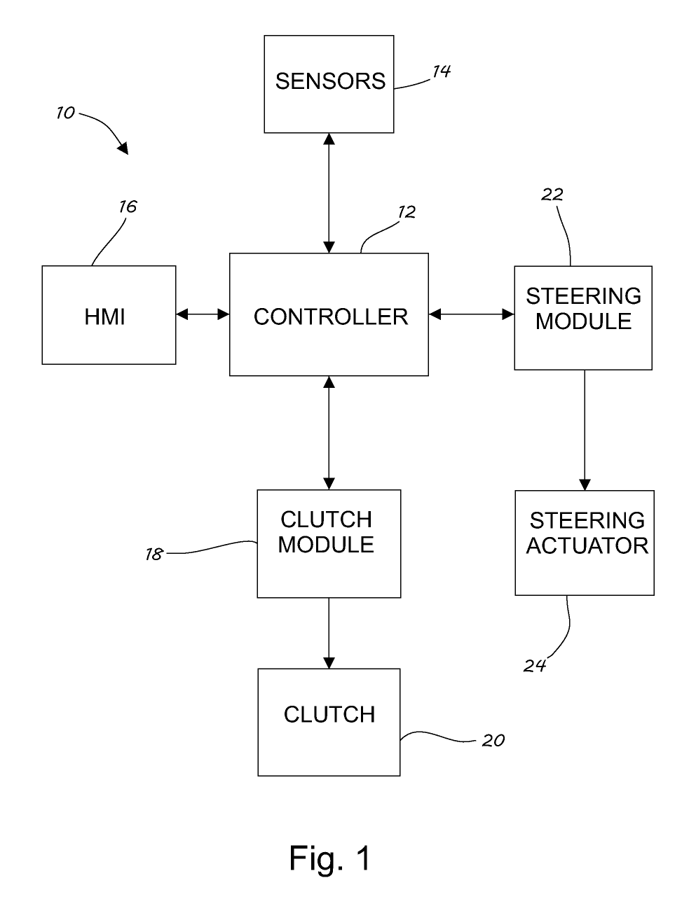

According to a number of variations as illustrated in FIG. 1, an automatic parking system 10 may provide new methods for parking a vehicle. The automatic parking system 10 may include a controller 12 that may interact with a number of sensors 14 for collecting information on the vehicle's surroundings, and also with a human machine interface 16 for receiving input from, and providing information to, the vehicle's driver. Although one controller 12 is illustrated, the automatic parking system 10 may employ multiple controllers for various functions, which may be networked. Therefore, controller 12 may alternatively be referred to as a controller network. The sensors 14 may provide a signal representative of the presence of, and distance to, surrounding objects or targets. The sensors 14 may operate on one or more of electromagnetic, radar, ultrasonic, imaging, or other technologies known to provide a signal representative of the proximity of surrounding objects. The sensing device may communicate data on the proximity of various objects to controller 12, and may receive activation or other signals from the controller 12. Through interaction of the sensors 14 and the controller 12, the distance to multiple objects may be established and the distance between those objects may be determined.

The human machine interface 16 may include elements in a vehicle's instrument panel to communicate with the vehicle's driver. A selector device may be provided to receive commands from the driver such as selecting activation of automatic parking system 10. The human machine interface 16 may be configured to receive various inputs from an operator by hand, foot, voice or other means. For example, the driver's application of the vehicle's brake may be communicated to the controller 12. In addition, the human machine interface 16 may enable remote activation of the automatic parking system 10 by a hand held or other device. The human machine interface 16 may also include visual, audible, or tactile feedback to the driver, and may provide specific instructions to the driver. For example, the driver may be advised of automatic parking initiation, and the human machine interface 16 may advise the driver to perform necessary functions.

The automatic parking system 10 may include a clutch module 18, which along with controller 12 may control a clutch actuator 20 of the vehicle. The clutch actuator 20 may be used to move the clutch to transmit or prevent the flow of power from the vehicle's engine to its manual operated transmission. The clutch actuator 20 may include a hydraulic, mechanical, electrical, or another motive means responsive to manual input from the vehicle's driver and automatic input from controller 12 or clutch module 18. One such device is described in provisional U.S. patent application 61/939,890 to a Hydraulic Power Pack Actuator For Controlling A manual Clutch filed Feb. 14, 2014, which is assigned to the assignee of the current invention and which is specifically incorporated herein by reference. The clutch module 18 may be an electronic module or similar device, configured to actuate the vehicle's clutch without the driver's depression of the clutch pedal. The controller 12 may provide control signals to the clutch module 18, to release or engage the clutch. The clutch module 18 may be a separate controller from the controller 12 or may be integrated there with as a single unit.

A steering module 22, may be included in the automatic parking system 10, which along with controller 12 may control a steering actuator 24 of the vehicle. The steering actuator 24 may be used to turn the steerable wheels of the vehicle. The steering actuator 24 may include a hydraulic, mechanical, electrical, or another motive means responsive to manual input from the vehicle's driver and automatic input from controller 12 or steering module 22. The steering module 22 may be an electronic module or similar device, configured to actuate the vehicle's steerable wheels without the driver turning the vehicle's steering wheel. The controller 12 may provide control signals to the steering module 22, to steer the vehicle's wheels. The steering module 22 may be a separate controller from the controller 12 or may be integrated there with as a single unit.

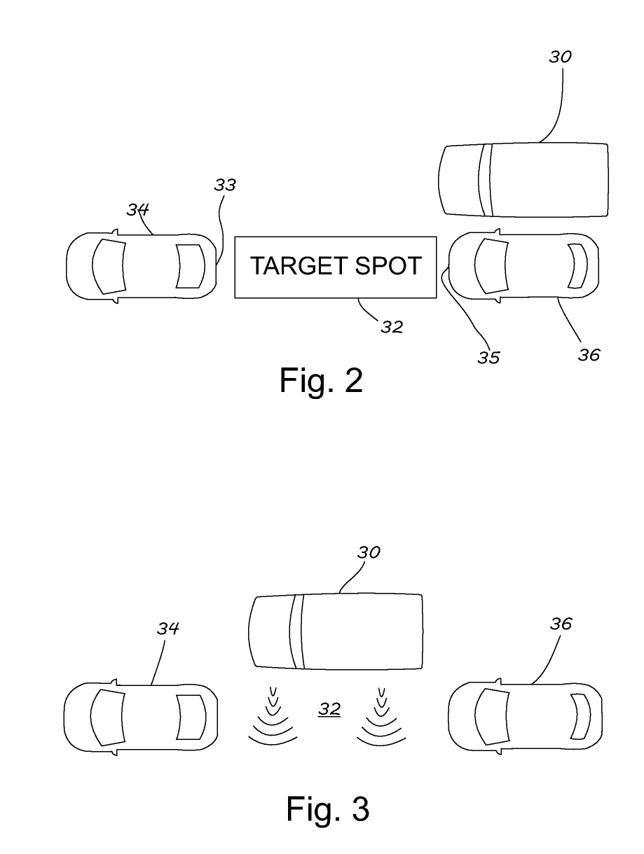

Referring additionally to FIG. 2, in a number of variations the driver of a vehicle 30 with the automatic parking system 10 of FIG. 1 may identify a target parking space 32. The target parking space 32 may be bordered in the front 33 by a first object, which may be a vehicle 34, and may be bordered in the rear 35 by a second object, which may be a vehicle 36. To initiate a parking event, the driver of vehicle 30 may stop the vehicle rearward of target parking space 32, preferably behind rear boundary 35, and to the side of vehicle 36. When stopped, the driver may apply the vehicle's brakes and manually actuate the clutch and may engage the transmission in first gear. If the vehicle is already in first gear when approaching the target parking space 32 in a vehicle equipped with an automatically modulated clutch, the driver may simply apply the vehicle's brake to stop the vehicle with first gear engaged. When the vehicle is stopped, the driver may select automatic parking system 10 activation through the human machine interface 16 of FIG. 1. If the clutch is depressed, the driver may release the clutch, and the driver may also release the vehicle's brake, and if necessary, the human machine interface 16 may notify the driver to undertake one or both actions.

Referring additionally to FIG. 3, according to a number of variations the automatic parking system 10 may initiate a scan of target parking space 32. With the vehicle 30 in first gear the vehicle's clutch may be automatically modulated, and the vehicle's steering may be automatically adjusted to autonomously move the vehicle 30 forward along the target parking space 32. As the vehicle 30 moves, the sensors 14 scan the surroundings to determine the perimeter of the target parking space 32. As the vehicle 30 passes the front boundary 33 of the target parking space 32, it may automatically stop along side vehicle 30, forward of target parking space 32, when equipped with an automated braking system. In a vehicle not equipped with an automated braking system, the automatic parking system 10 may notify the driver through the human machine interface 16 to apply the vehicle's brake. Once the vehicle 30 is stopped, the automatic parking system 10 may notify the driver through the human machine interface 16 to manually shift the vehicle into reverse. If the target parking space is not suitable for automatic parking of the vehicle 30, the automatic parking system 10 may notify the driver that automatic parking is not available at this location.

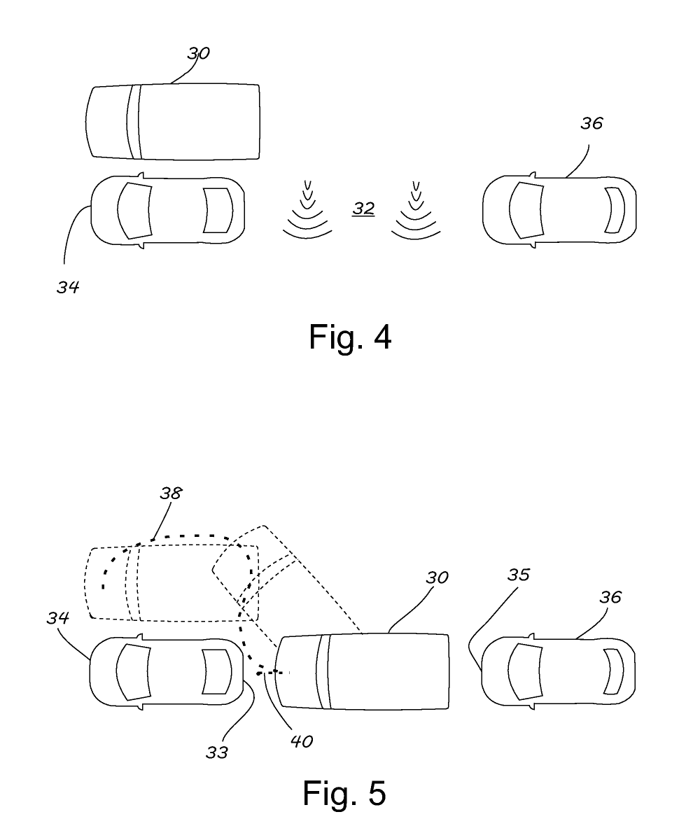

Referring additionally to FIG. 4, with vehicle 30 positioned alongside vehicle 34 and the target parking space 32 scanned, the automatic parking maneuver may proceed. The automatic parking system 10 may notify the driver to release the vehicle's brake, if depressed. In a number of variations as shown in FIG. 5, the automatic parking system 10 may execute the necessary parking maneuver 38 with the steering actuator 24 and may modulate the clutch system 20 to position the vehicle 30 between vehicles 34 and 36. If, at this stage, the distance between the vehicle 30 and the rear boundary 35 is less than the distance between the vehicle 30 and the front boundary 33, the automatic parking system 10 may notify the driver to manually shift the vehicle's transmission into first gear through the human machine interface 16. If necessary, the automatic parking system 10 may notify the driver to release the vehicle's brake through the human machine interface 16. The automatic parking system 10 may then proceed to move the vehicle 30 forward a distance 40 to balance the distances from vehicle 30 to vehicles 34 and 36. With the vehicle 30 parked in target parking space 32, the driver may shut down and exit the vehicle 30.

Through the system and method described herein, automatic parking of a vehicle with a manual transmission is accomplished. The description of variants herein is only illustrative of components, elements, acts, products, systems and methods considered to be within the scope of the invention and is not in any way intended to limit such scope by what is specifically disclosed or not expressly set forth. Components, elements, acts, products, systems and methods may be combined and rearranged other than as expressly described herein and still are considered to be within the scope of the invention.

Variation 1 may include a method of parking a vehicle, which may include providing a vehicle with a manual transmission. The vehicle may be equipped with an automatically modulated clutch. A target parking space may be identified. The clutch may be modulated automatically through a controller network to move the vehicle while scanning the target parking space. The vehicle may be automatically steered through the controller network while simultaneously modulating the clutch automatically through the controller network to move the vehicle into the target parking space.

Variation 2 may include a method according to variation 1 and may include the step of manually stopping the vehicle at a first location that is rearward and to a side of the target parking space.

Variation 3 may include a method according to variation 1 or 2 and may include the step of autonomously stopping the vehicle at a second location that is forward and to the side of the target parking space, after scanning the target parking space.

Variation 4 may include a method according to any of variations 1 through 3 and may include the step of manually shifting the manual transmission into reverse after stopping the vehicle at the second location.

Variation 5 may include a method according to any of variations 1 through 4 and may include the steps of providing an instruction to shift the vehicle into a forward gear after the vehicle is moved into the target parking space, and autonomously moving the vehicle forward in the target parking space.

Variation 6 may include a method of parking a vehicle that is equipped with a manually actuated transmission. The vehicle may be equipped with an automatically modulated clutch. A target parking space may be identified and the vehicle may be stopped at a first location that is rearward and to a side of the target parking space. The clutch may be modulated automatically through a controller network to autonomously move the vehicle in a forward direction while scanning the target parking space. The vehicle may be stopped at second location that is forward and to the side of the target parking space. The transmission may be manually shifted into reverse. The vehicle may then be steered automatically while the controller network simultaneously modulates the clutch automatically to move the vehicle into the target parking space.

Variation 7 may include a method according to variation 6 and may include the step of notifying the driver to shift the manually actuated transmission into first gear after the vehicle is stopped at the first location.

Variation 8 may include a method according to variation 6 or 7 and may include the step of notifying the driver to shift the manually actuated transmission into reverse gear after the vehicle is stopped at the second location.

Variation 9 may include a method according to any of variations 6 through 8 and may include the step of notifying the driver to shift the manually actuated transmission into first gear after the vehicle is moved into the target parking space.

Variation 10 may include a system for automatically parking a vehicle that has an engine and a manually operated transmission. The system may include a sensor configured to detect objects proximate to the vehicle, and a steering system for steering the vehicle. A clutch may be configured to engage and disengage the engine and the manual operated transmission. A controller network may autonomously control the steering and may autonomously actuate the vehicle's clutch. The controller network may determine a boundary of a target parking space based on location of the objects detected by the sensor, and may autonomously control the steering and actuate the clutch to effect movement of the vehicle into the target parking space.

Variation 11 may include a system according to variation 10 wherein the vehicle may include a brake. The system may include a human machine interface through which a notification is given to manually release the brake when the manually operated transmission is in gear.

Variation 12 may include a system according to variation 11 wherein the human machine interface provides an instruction for the manually operated transmission to shift between gears.

Variation 13 may include a system according to any of variations 10 through 12 wherein the manually operated transmission may be shifted between gears manually and may be engaged and disengaged with the engine both manually and autonomously.

Variation 14 may include a system according to any of variations 10 through 13 wherein the transmission is engaged and disengaged with the engine autonomously while the boundary is being determined.

Variation 15 may include a system according to any of variations 10 through 14 wherein the transmission may be engaged and disengaged with the engine manually, when the transmission is shifted between gears.

The above description of select variations within the scope of the invention is merely illustrative in nature and, thus, variations or variants thereof are not to be regarded as a departure from the spirit and scope of the invention.

What is claimed is:

1. A method of parking a vehicle comprising the steps of: providing a vehicle with a manual transmission; equipping the vehicle with a clutch that is automatically modulated; identifying a target parking space; modulating the clutch automatically through a controller network to move the vehicle while scanning the target parking space; and steering the vehicle automatically through the controller network while simultaneously modulating the clutch automatically through the controller network to move the vehicle into the target parking space.

2. The method according to claim 1 including the step of manually stopping the vehicle at a first location that is rearward and to a side of the target parking space.

3. The method according to claim 2 including the step of autonomously stopping the vehicle at a second location that is forward and to the side of the target parking space, after scanning the target parking space.

4. The method according to claim 3 including the step of manually shifting the manual transmission into reverse after stopping the vehicle at the second location.

5. The method according to claim 1 including the steps of providing an instruction to shift the vehicle into a forward gear after the vehicle is moved into the target parking space; and autonomously moving the vehicle forward in the target parking space.

6. A method of parking a vehicle that is equipped with a manually actuated transmission comprising the steps of: equipping the vehicle with an automatically modulated clutch; identifying a target parking space; stopping the vehicle at a first location that is rearward and to a side of the target parking space; modulating the clutch automatically through a controller network to autonomously move the vehicle in a forward direction while scanning the target parking space; stopping the vehicle at second location that is forward and to the side of the target parking space; manually shifting the manually actuated transmission into a reverse gear; and steering the vehicle automatically through the controller network while simultaneously modulating the clutch automatically through the controller network to move the vehicle into the target parking space.

7. The method according to claim 6 including the step of providing a first notification to shift the manually actuated transmission into a first gear after the vehicle is stopped at the first location.

8. The method according to claim 7 including the step of providing a second notification to shift the manually actuated transmission into the reverse gear after the vehicle is stopped at the second location.

9. The method according to claim 8 including the step of providing a third notification to shift the manually actuated transmission into the first gear after the vehicle is moved into the target parking space.

10. A system for automatically parking a vehicle having an engine and a manually operated transmission, the system comprising: a sensor configured to detect objects proximate to the vehicle; a steering system for steering the vehicle; a clutch configured to engage and to disengage the engine and the manually operated transmission; a controller network autonomously controlling the steering system, and the controller network being configured to autonomously actuate the clutch; wherein the controller network is configured to determine a boundary of a target parking space based on location of the objects detected by the sensor, and the controller network autonomously controls the steering system and actuates the clutch effecting movement of the vehicle into the target parking space.

11. The system according to claim 10 wherein the vehicle includes a brake and further comprising a human machine interface through which a notification is given to manually release the brake when the manually operated transmission is in a gear.

12. The system according to claim 11 wherein the human machine interface provides an instruction to shift the manually operated transmission.

13. The system according to claim 10 wherein the manually operated transmission is shifted manually and is engaged and disengaged with the engine both manually and autonomously.

14. The system according to claim 13 wherein the manually operated transmission is engaged and disengaged with the engine autonomously while the boundary is being determined.

15. The system according to claim 14 wherein the manually operated transmission is engaged and disengaged with the engine manually, when the manually operated transmission is shifted manually.
